(19) United States
(12) Patent Application Publication
(10) Pub. No.: US 2014/0142739 A1
(43) Pub. Date: May 22, 2014

(54) Method for Improving Product Roll Quality of a Web Forming Process

(71) Applicant: ABB TECHNOLOGY AG, Zurich (CH)

(72) Inventors: Peter Quang Tran, Dublin, OH (US); Gary Fulton Morris, Frostburg, MD (US); Kevin D. Starr, Lancaster, OH (US); Robert Horton, Alpharetta, GA (US)

(73) Assignee: ABB TECHNOLOGY AG, Zurich (CH)

(21) Appl. No.: 13/678,937

(22) Filed: Nov. 16, 2012

(51) Int. Cl. G05D 5/02

(52) U.S. Cl. 700/127

(57) ABSTRACT

An initial setpoint determiner that determines an initial setpoint for controlling a web forming process based on a sensed signal indicative of a characteristic of an output generated by the web forming process, a setpoint adjuster that periodically determines an adjustment signal based on local regional error characteristics of the output generated by the web forming process, and a final setpoint determiner that determines a final setpoint signal that controls the web forming process based on the initial setpoint and the adjustment signal.

### TECHNICAL FIELD OF THE INVENTION

The following generally relates to controlling web forming processes, which, generally, are processes which include creation of loosely held together sheet structure or flat sheets, e.g., by the laying down of fibers. While the present invention can be applied to a variety of web forming processes (e.g., paper, plastic, fabric, etc.), it will be described herein with particular reference to a paper machine.

### BACKGROUND

In paper manufacturing, local regions of stagnant peaks and valleys can lead to poor roll quality like ridge formation or baggy (stretchy) rolls as product is accumulated onto a steel spool to form the roll. A typical roll can grow to several meters in diameter. Poor roll quality defect is the result of localized compounding of a stagnant peak and valley pattern during the course of building the roll. As the roll grows in diameter, the pattern compounds, causing the peak to increase in height and causing the valley to form a larger depression. As a result of the defect, ridges form in the roll. Even more, once the roll exceeds a given diameter, sheet stretching exists, which causes a roll to become “baggy.” Baggy rolls can result in costly problems such as line breaks or printing defects.

To improve roll quality, mechanical (side to side) oscillations of the sheet forming table or reel spool to distribute any stagnant peaks and valleys over a cross-directional region, preventing layering in the same spot. However, this mechanical approach requires special machinery to be added to a paper machine, which may not be possible due to space or cost constraints. Without a mechanical device, human operators must be relied upon to continuously make adjustments with limited success.

Uniformity of a property of a web of sheet material can be specified as variations in two perpendicular directions: the machine direction (MD), which is in the direction of web movement during production, and the cross-machine direction (CD), which is perpendicular to the MD. Different sets of actuators are used to control the variations in each direction. CD variations appear in measurements known as CD profiles and are typically controlled by an array of actuators located side-by-side and across the web width.

### SUMMARY

Aspects of the application address the above matters, and others.

In one aspect, an initial setpoint determiner that determines an initial setpoint for controlling an industrial process based on a sensed signal indicative of a characteristic of an output generated by the industrial process, a setpoint adjuster that periodically determines an adjustment signal based on local regional error characteristics of the output generated by the industrial process, and a final setpoint determiner that determines a final setpoint signal that controls the industrial process based on the initial setpoint and the adjustment signal.

In another aspect, a method determining an initial setpoint for controlling an industrial process based on a sensed signal indicative of a characteristic of an output generated by the industrial process, periodically determining an adjustment signal based on local regional error characteristics of the output generated by the industrial process, determining a final setpoint signal that controls the industrial process based on the initial setpoint and the adjustment signal.

In another aspect, a computer readable storage medium is encoded with computer executable instructions, which, when executed by a processor, causes the processor to: determine an initial setpoint for controlling an industrial process based on a sensed signal indicative of a characteristic of an output generated by the industrial process, periodically determine an adjustment signal based on local regional error characteristics of the output generated by the industrial process, and determine a final setpoint signal that controls the industrial process based on the initial setpoint and the adjustment signal.

### FIGURES

The present application is illustrated by way of example and not limitation in the figures of the accompanying drawings, in which like references indicate similar elements and in which:

FIG. 1 illustrates an example system in connection with an industrial plant control system.

FIG. 2 illustrates an example control signal generator for an industrial plant control system.

FIG. 3 illustrates an example perturber control for generation of an adjusted setpoint signal.

FIG. 4 illustrates an example saw tooth spatial dithering pattern.

FIG. 5 illustrates an example sine wave spatial dithering pattern with predetermined zones excluded.

FIG. 6 illustrates an example final setpoint adjustment signal in the form of a feedback control setpoint with predetermined zones excluded (shown in right shaded area).

FIG. 7 illustrates a comparison between a setpoint signal and the maximum deviation from the de-trend shape.

FIG. 8 illustrates dither magnitudes for various zones.

FIG. 9 illustrates compression of steady-state setpoint shapes.

FIG. 10 illustrates dithering activation of a final setpoint signal.

FIG. 11 illustrates an industrial control plant method that adjusts a setpoint value.

### DETAILED DESCRIPTION

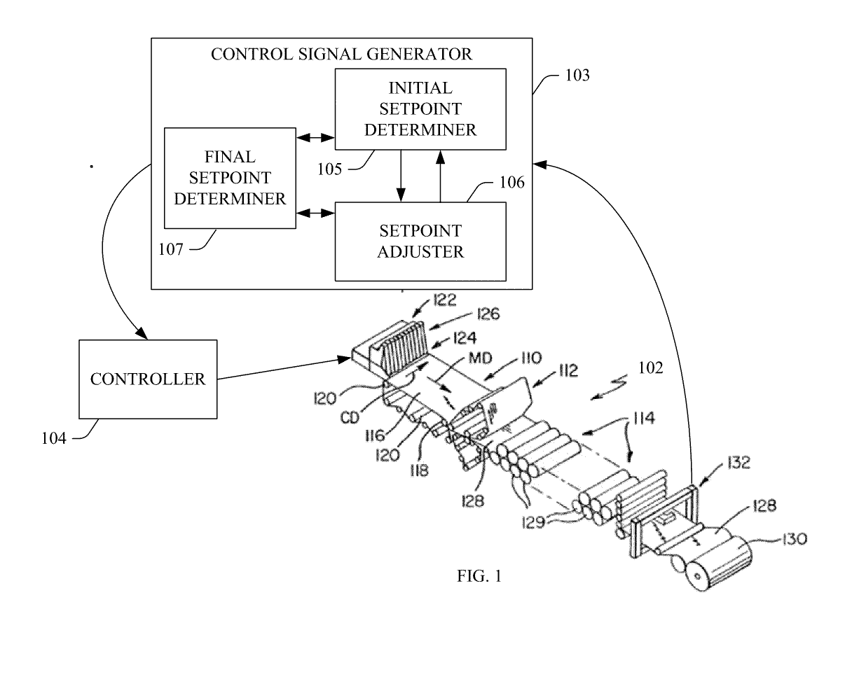

FIG. 1 illustrates a system that comprises a paper making machine 102, a control signal generator 103 that generates a control signal for controlling the paper making machine 102, and a controller 104 that controls the paper making machine 102 based on a control signal. An example of a suitable paper mill is discussed in U.S. Pat. No. 7,648,614, assigned to ABB, Inc., which is incorporated by reference in its entirety herein.

The control signal generator 103 comprises an initial setpoint determiner 105, a setpoint adjuster 106, and a final setpoint determiner 107. The initial setpoint determiner 105 monitors properties of the paper making machine 102 and generates an initial control signal that includes an initial setpoint based at least on the monitored properties. The setpoint adjuster 106 generates an adjustment signal, which, as described in greater detail below, is based on at least one of the monitored properties in an identified local region and the initial control signal.

The final setpoint determiner 107 generates a final setpoint to control the machine 102 based on the initial control signal and the adjustment signal. Generally, the adjustment signal temporarily perturbs the initial setpoint so as to mitigate undesired characteristics (e.g., peaks and/or valleys) in the paper making process. This may result in enhancement of the structural integrity of a paper and/or paper roll under construction. For example, peaks and valleys in a roll under construction may be reduced relative to not employing the adjustment signal from the adjusted setpoint determiner 106.

The illustrated paper making machine 102 includes a wire section 110, a press section 112, and a dryer section 114 with a midsection broken away to indicate that other web processing components, such as a sizing section, additional dryer sections and/or other components may be included. The wire section 110 comprises a wire belt 116 wound around a drive roller 118 and a plurality of guide rollers 120 arranged relative to the drive roller 118. The drive roller 118 is driven so that an upper side of the wire belt 116 moves in a machine direction (MD). A headbox 122 receives pulp slurry (e.g., paper stock) that is discharged through a slice lip 124, which is controlled using a plurality of CD actuators 126 (e.g., slice screws). Dilution valves can also be used onto the upper side of the wire belt 116. The pulp slurry is drained of water on the wire belt 116 to form a web 128 of paper.

The water drained from the pulp slurry to form the web 128 has been referred to as white-water with pulp in a low concentration and is collected under the wire section 110 and recirculated in the paper making machine 102. The web 128 is further drained of water in the press section 112 and is delivered to the dryer section 114. The dryer section 114 comprises a plurality of steam-heated drums 129. The web 128 may be processed by other components in the MD along the process and is ultimately taken up by a web roll 130. A sensor 132 senses characteristics of the web 128. The sensor 132 is located substantially adjacent to the web roll 130. It is noted that one or more other sensors can be used, including a stationary sensor for measuring part or the entire web 128 and that the sensor 132 can be positioned at other locations along the web 128. Other paper making machines are also contemplated herein.

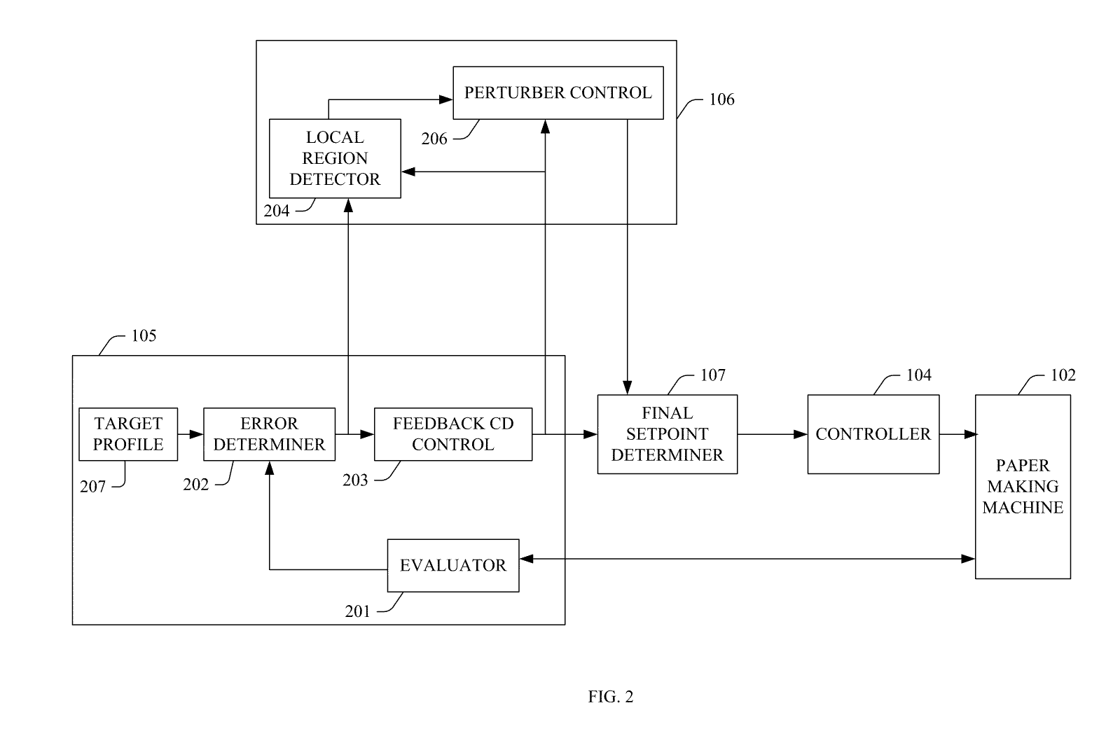

Turning to FIG. 2, examples of the initial setpoint determiner 105, the setpoint adjuster 106 and the final setpoint determiner 107 are schematically illustrated in connection with the controller 104 and the paper making machine 102.

As briefly discussed above, the sensor 132 senses process properties of the web 128 (FIG. 1). Examples of a sensed process property include paper weight, paper moisture, caliper profiles, etc. The sensed properties are combined by an evaluator 201 to provide a monitored properties signal. Accordingly, the monitored properties signal indicates the at least one current property of the roll sensed by the sensor 132.

The initial setpoint determiner 105 includes an error determiner 202 that subtracts the monitored properties signal from a target control signal of a target profile 207, creating an error signal. In one instance, the target control signal represents a preferred state of the at least one sensed property obtained by the sensor 132. The error signal indicates a current state of the paper making machine 102. The initial setpoint determiner 105 also includes a feedback CD control 203 that generates an initial setpoint signal based on the error signal, and makes the initial setpoint signal available to the final setpoint determiner 107. Execution rate of the inner components of the initial setpoint determiner 105 is dictated by availability of the sensed process property from evaluator 201. Typical execution rate is longer than every 20 to 60 seconds, which is the typical scan update time for generating a new sensed process property profile.

The setpoint adjuster 106 includes a local region detector 204. The local region detector 204 evaluates the error signal and the initial setpoint signal, detecting build problems on a sheet as the sheet is being rolled. The detected build problems include, but are not limited to, undesired patterns on the sheet, such as peaks or valleys, which cause non-uniformities in a roll created from the sheet. The detected build problems and an identification of a location of the local region where build problems exist are included in a build signal.

The setpoint adjuster 106 also includes a perturber control 206 that generates a perturbation value based on the build signal and the initial setpoint. The perturbation value, in one instance, simulates the effects of oscillating mechanical devices and ultimately affects the short-term variation of the paper making machine 102. The perturbation value is generated to disrupt or perturb the sheet, which facilitates mitigating defects in the roll under construction.

The final setpoint determiner 107 adds the adjustment signal and the initial setpoint signal to create an adjusted setpoint signal with a final setpoint value. The controller 104 controls production of paper of the paper making machine 102 in accordance with the final setpoint signal.

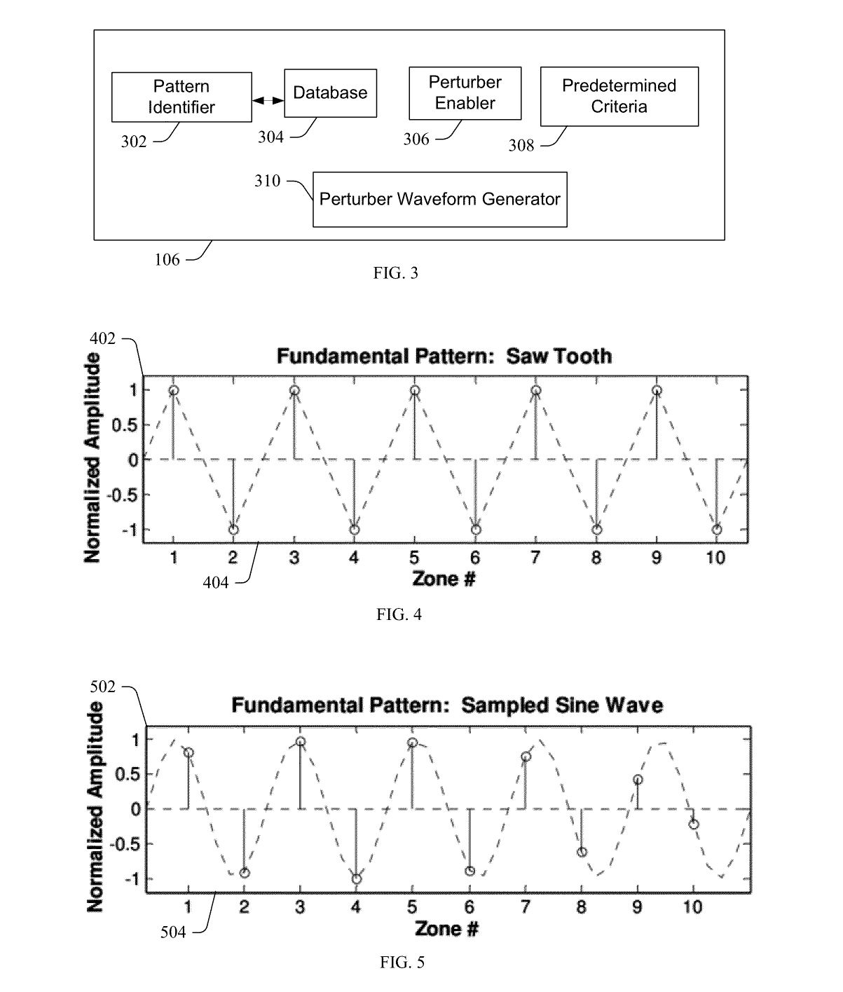

Next, at FIG. 3, an example of the setpoint adjuster 106 is illustrated.

A pattern identifier 302 receives the build signal from the local region detector 204 (FIG. 2), as briefly discussed above. The pattern identifier 302 identifies a particular predetermined spatial dithering pattern (stored in a database 304 or the like) that facilitates mitigating a particular defect(s) in the indicated local region. If the build signal is equal to zero or is below a predetermined threshold, the pattern identifier 302 does not identify a pattern. Also, as described below, a perturber enabler 306 turns off spatial dithering if the build signal is zero or below a given threshold.

In one instance, the pattern identifier 302 determines a spatial dithering pattern that disperses non-uniformities present in a roll. The spatial dithering pattern introduces, for example, fast CD (profile) changes into the adjustment signal, which facilitates dispersing stagnant peaks and/or valleys in the roll. The pattern identifier 302 selects a pattern that dithers the adjustment signal with an excitation pattern resembling peaks and valleys in the roll. For example, when the local region detector 204 detects drastic peaks and valleys, the pattern identifier 302 may assign a saw tooth pattern (an example of which is discussed below) as the dithering pattern. If the local region detector 204 detects more subtle peaks and valleys in the roll, the pattern identifier 302 may identify a sine wave pattern (an example of which is discussed below) to dither the adjustment signal and disperse imperfections.

The perturbation value (and thus the adjustment signal) is changed incrementally for a given detected pattern. Consequently, the amplitude of the adjustment signal can be increased gradually over time to more aggressively correct any roll defect. Also, the adjustment signal can be region-specific, meaning that the perturbation value can be generated to be incrementally changed for a localized control zone in the region where roll defects are apparent. The incremental changes are added to a sub-part of the target control signal, via the final setpoint determiner 107 (FIG. 2) that corresponds to the localized zone and, generally, does not interfere with other portions of the control signal.

The perturber enabler 306 generates a perturber enable signal, which determines periods of time when the setpoint adjuster 106 turns spatial dithering on. The perturbation value affects the steady-state performance of the controller 104. If problems develop during a given time window during manufacture of the roll, the perturber enabler 306 activates dithering by outputting the perturber enable signal. In one example, the perturber enabler 306 uses the build signal of the local region detector 204 to determine a probability of the detected region having a build problem. The perturber enabler 306 transmits a perturber disable signal or no signal, disabling dithering during periods of time when problems in the sheet are unlikely to develop. Alternatively, the perturber enabler 306 outputs the perturber enable signal, enabling dithering, when problems are likely to develop.

The predetermined criteria 308 may set the frequency of the dithering pattern. For example, the frequency of a saw tooth dithering pattern (and as a result, the adjustment signal) can be increased by frequency criteria provided by the predetermined criteria 308. The predetermined criteria 308 may dither the adjustment signal at a greater frequency than the initial setpoint determiner 105. As such, process perturbation can be performed at a greater frequency than introducing the frequency before the initial setpoint determiner 105. The identified pattern, perturber enable signal, and the predetermined criteria 308 are used by the perturber waveform generator 310 to generate a waveform (e.g. the adjustment signal). The adjustment signal generated by perturber waveform generator 310 results in more rapid dithering than the execution periods of the initial setpoint determiner 105 would provide without the adjustment signal.

The adjustment signal is output to the final setpoint determiner. The final setpoint determiner 107 is implemented in an open-loop summation point, or feed forward point, to bypass dependency on the initial setpoint determiner 105. Choice of the open-loop summation point also alleviates the need to aggressively tune the initial setpoint determiner 105. Combining the addition of a flipping localized setpoint dithering pattern with the permissive state and a faster setpoint output oscillator, the dithering technique induces a higher level of process perturbation than available methods through feedback control. The final setpoint signal is generated by combining the adjustment signal and the error signal. The final setpoint signal is output by the final setpoint determiner 107 to the controller 104, which can implement the final setpoint signal in the paper making portion 102.

FIG. 4 illustrates an example saw-tooth pattern. As shown, this pattern has alternating, and equal, positive and negative values. A vertical axis 402 corresponds to a normalized amplitude of the saw-tooth signal. A horizontal axis 404 corresponds to a zone number. In this instance, the zone numbers represented by an odd number are dithered with a positive peak value of the saw tooth pattern. The zone numbers represented by an even number are dithered with a maximum negative value of the saw-tooth pattern. By continuously alternating positive and negative values for the zones at a frequency set by predetermined criteria 308, fast changing CD (profile) is introduced into the paper making process. Since the setpoint of the manipulated local profiling zones are manipulated with alternating positive and negative values, the average setpoint value for all zones does not change. Moreover, the setpoint adjuster 106 can exclude zones for setpoint dithering through the use of the perturber enable component 306, for example.

FIG. 5 illustrates an example sine wave pattern. As shown, this pattern alternates from positive to negative values. A vertical axis 502 corresponds to a normalized amplitude of the sine wave signal. A horizontal axis 504 corresponds to a zone number. In this instance, the setpoint adjustment amplitude and sign (positive or negative) of the zones change due to the non-linear nature of the sine wave signal and a changing spatial (CD) wavelength of the sine wave pattern on consecutive execution of the setpoint adjuster 106.

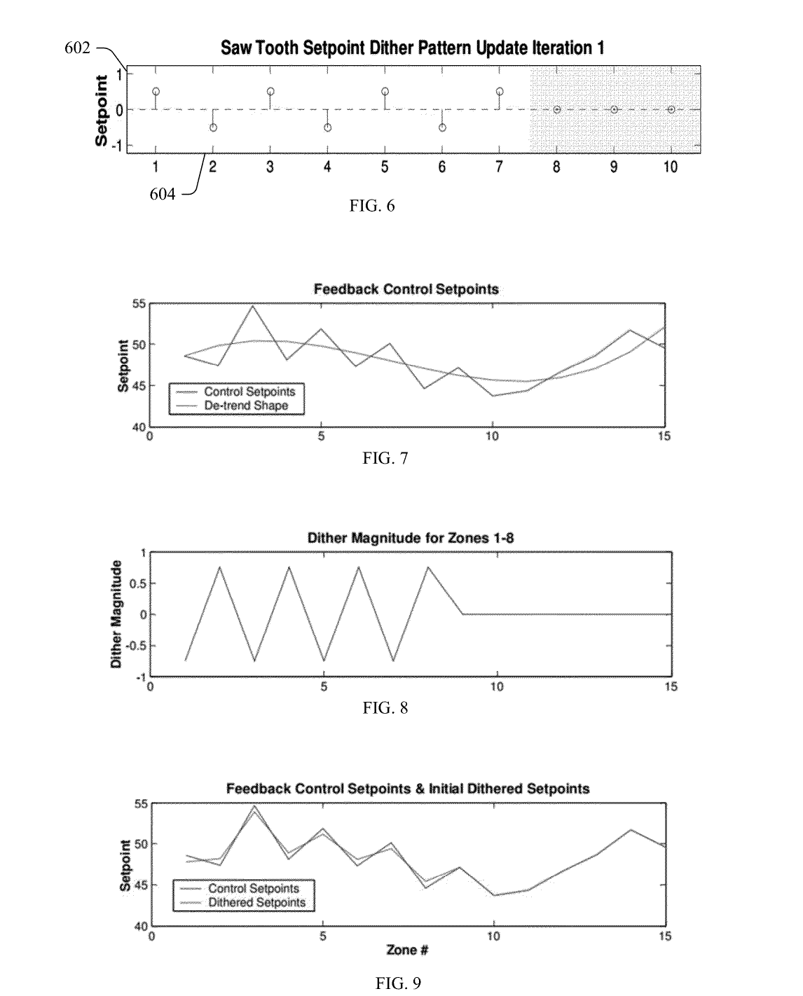

FIG. 6 illustrates an example saw tooth setpoint dither pattern. A vertical axis 602 provides a magnitude for the alternating positive and negative values of the setpoint adjustment signal. A horizontal axis 604 corresponds to a zone. In this instance, the zone numbers represented by an odd number are dithered with a positive value of the saw-tooth pattern. The zone numbers represented by an even number are dithered with a maximum negative value of the saw-tooth pattern. By alternating positive and negative values for the zones at a frequency set by predetermined criteria 308, fast changing CD (profile) is introduced into the paper making process. FIG. 6 also shows zones (8, 9 and 10) excluded from dithering. As shown, the final setpoint signal along a vertical axis changes by a positive to negative setpoint adjustment value for even and odd zone values, which are represented along a horizontal axis.

FIGS. 7-9 show a technique for minimizing the impact of the setpoint dithering on the average process profile and minimization of first or second difference limitations on the setpoint array. To this end, initial incremental setpoint changes are applied to the steady-state feedback control setpoint in the direction that will reduce the first and second difference magnitudes of the steady-state setpoint. Accordingly, the initial incremental setpoint changes compress the setpoint shape. Subsequent to the initial incremental setpoint change, the first and second difference magnitude will change between the steady-state magnitude and a reduced magnitude.

The initial direction of move is determined by de-trending the setpoint shape of the detected local region and comparing the setpoint of the control zone with the maximum deviation from the de-trend shape, as shown in FIG. 7. If the setpoint comparison of the maximum deviated zone is greater than the de-trend shape, then the initial incremental change for this zone is negative and the incremental change of the adjacent control zones is dictated by the chosen fundamental excitation pattern (e.g. saw tooth). An example of this behavior is shown in FIG. 8 in the form of dither magnitudes for zones 1-8. In this example, as shown in FIG. 7, the maximum deviation from the de-trend shape for the selected dithering zones 1-8 occurs at zone 3. This maximum deviation is positive, so the initial incremental setpoint change for zone 3 is negative and the incremental change of the adjacent control zones to the left and right of zone 3 is dictated by the chosen fundamental excitation pattern. Conversely, if the setpoint comparison of the maximum deviated zone is less than the de-trend shape, the initial incremental change for the zone where the maximum deviation is detected is positive. An illustrative example of how the initial incremental change scheme results in compression of the steady-state setpoint shape is shown in FIG. 9.

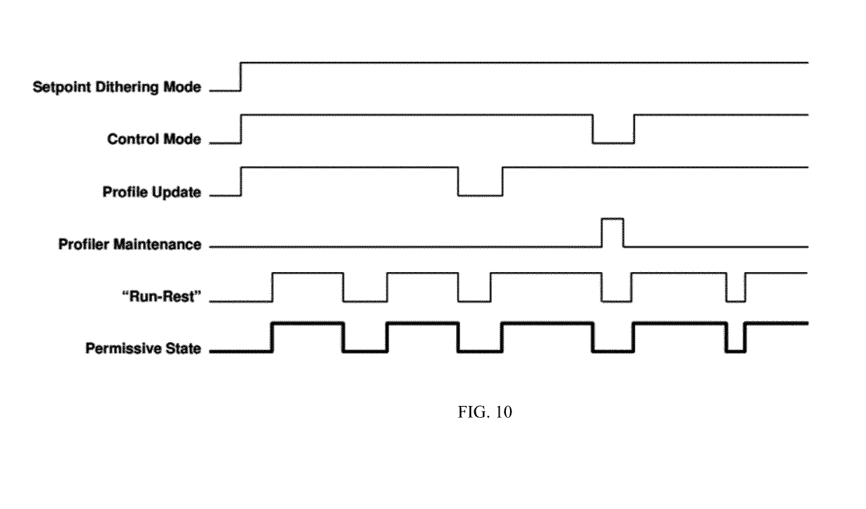

Dithering of the steady-state setpoint shape with incremental changes is for the purpose of inducing fast changes into the controller 104, and not to drastically interfere with the operation or affect the steady-state performance of the initial setpoint determiner 105. As noted above, the perturber enabler 306 establishes a time window when local identified regions can be dithered with a perturbation value. FIG. 10 illustrates signals that are analyzed by the perturber enabler 306 to activate dithering. For example, the perturber enabler 306 takes into account a control mode of the initial setpoint determiner 105, a controlled profile update status of the evaluator 201 in the initial setpoint determiner 105, and a maintenance status of the profiler controller 104. For the perturber enabler 306 to activate dithering, the control mode of the initial setpoint determiner 105 must be active, the controlled profile update status of the evaluator 201 must be affirmative, and the profiler controller 104 must not be in the maintenance mode.

Another signal that is analyzed by the perturber enabler 306 to activate dithering is a “run-rest” signal. The run-rest signal is a clocked signal that is synchronized with the start event for building a roll of product. This signal is set false at the start of roll build and is set true after a specified elapsed time from start of roll build. The elapse time from start of roll build can be set to a duration shorter than when roll build quality problems typically develop during a roll build cycle. This signal is AND with the aforementioned signals to allow dithering to run. Finally, perturber enabler 306 monitors a master on/off setpoint dithering signal. The on/off signal allows an individual to completely override the perturber enabler 306. An example of dithering activation is shown in FIG. 10.

In the present application, the predetermined criteria 308 can include a frequency of dithering activation that results in dithering greater than once per scan. Accordingly, dithering can be performed, for example, every 5 to 15 seconds, instead of every 30 or 45 seconds, etc. Generally, the initial setpoint determiner 105 can be tuned conservatively to activate once per scan, with the objective of minimizing error in the controlled profiler measurement. If the initial setpoint determiner 105 is tuned too aggressively, over corrections may exist. An example of the final setpoint signal is shown in FIG. 9, labeled as “dithered setpoints”, after taking into account the adjusted setpoint signal.

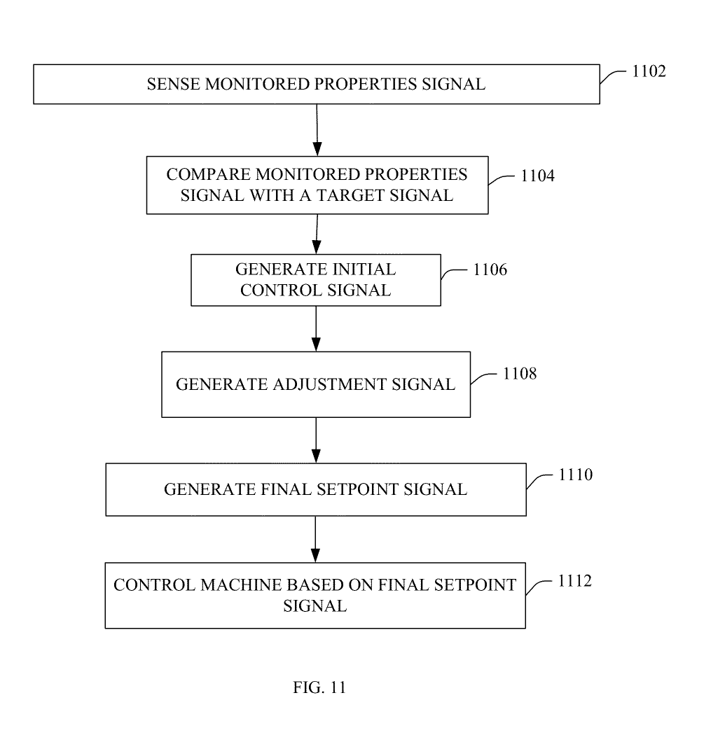

FIG. 11 illustrates a method in accordance with the present invention.

It is to be appreciated that the ordering of the acts in the methods described herein is not limiting. As such, other orderings are contemplated herein. In addition, one or more acts may be omitted and/or one or more additional acts may be included.

At 1102, machine properties are sensed. The properties can include, for example, in the pulp and paper industry, at least one of paper weight, paper moisture, caliper profiles, etc. of a sheet being rolled.

At 1104, the properties are compared with a target control signal and an error signal is generated.

At 1106, an initial setpoint signal is generated based on the error signal.

At 1108, an adjustment signal is generated based on the error signal and the initial control signal.

At 1110, a final setpoint signal is generated based on the initial setpoint signal and the adjustment signal.

At 1112, a machine is controlled based on the final setpoint signal.

The above may be implemented by way of computer readable instructions, which when executed by a computer processor(s), cause the processor(s) to carry out the described techniques. In such a case, the instructions are stored in a computer readable storage medium associated with or otherwise accessible to the relevant computer.

Of course, modifications and alterations will occur to others upon reading and understanding the preceding description. It is intended that the invention be construed as including all such modifications and alterations insofar as they come within the scope of the appended claims or the equivalents thereof.

What is claimed is:

1. A system, comprising:
an initial setpoint determiner that determines an initial setpoint for controlling a web forming process based on a sensed signal indicative of a characteristic of an output generated by the web forming process;
a setpoint adjuster that periodically determines an adjustment signal based on local regional error characteristics of the output generated by the web forming process; and
a final setpoint determiner that determines a final setpoint signal that controls the web forming process based on the initial setpoint and the adjustment signal.

2. The system of claim 1, wherein the adjustment signal temporarily perturbs the initial setpoint so as to mitigate undesired characteristics in the web forming process.

3. The system of claim 2, wherein the web forming process is a paper making process and the adjustment signal mitigates at least one of peaks or valleys in a paper roll under construction by the paper making process.

4. The system of claim 1, the initial setpoint determiner, comprising:
an error determiner that determines an error signal based on a difference between a target profile and the sensed signal.

5. The system of claim 1, the setpoint adjuster, comprising:
a local region detector that evaluates the error signal and the initial setpoint and generates a build signal that identifies a local region where a build problem exists and a type of the build problem; and
a perturber control that generates the adjustment signal based on the build signal and the initial setpoint.

6. The system of claim 5, wherein the adjustment signal affects a short-term variation of the industrial process.

7. The system of claim 5, wherein the adjustment signal includes a spatial dithering pattern.

8. The system of claim 7, wherein the spatial dithering pattern disperses non-uniformities.

9. The system of claim 7, wherein the spatial dithering pattern introduces fast changes into the adjustment signal.

10. The system of claim 7, wherein the spatial dithering pattern includes one of a sine wave or saw-tooth wave.

11. The system of claim 7, wherein a frequency of the spatial dithering pattern is based on a predetermined criteria.

12. The system of claim 7, wherein the adjustment signal incrementally changes for a given spatial dithering pattern.

13. The system of claim 12, wherein an amplitude of the adjustment signal increases or decreases over time.

14. The system of claim 7, wherein the adjustment signal is region-specific to a localized control zone where a defect is present.

15. The system of claim 5, further comprising:
a perturber enabler that disables the setpoint adjuster in response to the local regional error characteristics being below a predetermined threshold.

16. The system of claim 1, wherein the final setpoint determiner includes an open-loop configuration, thereby bypassing a dependency on the initial setpoint determiner.

17. A method, comprising:
determining an initial setpoint for controlling a web forming process based on a sensed signal indicative of a characteristic of an output generated by the web forming process;
periodically determining an adjustment signal based on local regional error characteristics of the output generated by the web forming process; and
determining a final setpoint signal that controls the web forming process based on the initial setpoint and the adjustment signal.

18. The method of claim 17, wherein the adjustment signal temporarily perturbs the initial setpoint so as to mitigate undesired characteristics in the web forming process.

19. The method of claim 17, further comprising:
determining an error signal based on a difference between a target profile and the sensed signal;
evaluating the error signal and the initial setpoint;
generating a build signal that identifies a local region where a build problem exists and a type of the build problem; and
generating the adjustment signal based on the build signal and the initial setpoint.

20. The method of claim 17, wherein the adjustment signal includes a spatial dithering pattern.

21. The method of claim 20, wherein the spatial dithering pattern resembles the local regional error characteristics.

22. The method of claim 20, wherein the spatial dithering pattern disperses non-uniformities.

23. The method of claim 20, wherein the spatial dithering pattern introduces fast changes into the adjustment signal.

24. The method of claim 20, wherein the spatial dithering pattern includes one of a sine wave or saw-tooth wave.

25. The method of claim 20, wherein the adjustment signal is region-specific to a localized control zone where a defect is present.

26. A computer readable storage medium encoded with one or more computer executable instructions, which, when executed by a processor of a computing system, causes the processor to:
determine an initial setpoint for controlling a web forming process based on a sensed signal indicative of a characteristic of an output generated by the web forming process;
periodically determine an adjustment signal based on local regional error characteristics of the output generated by the web forming process; and
determine a final setpoint signal that controls the web forming process based on the initial setpoint and the adjustment signal.
